(19) United States
(12) Patent Application Publication
(10) Pub. No.: US 2018/0063306 A1
(43) Pub. Date: Mar. 1, 2018

(54) Cell Phone Case with Reconfigurable Plates

(71) Applicant: Bruce Allen Scannell, JR., Carlsbad, CA (US)

(72) Inventor: Bruce Allen Scannell, JR., Carlsbad, CA (US)

(21) Appl. No.: 15/487,311

(22) Filed: Apr. 13, 2017

Related U.S. Application Data
(60) Provisional application No. 62/378,649, filed on Aug. 23, 2016.

(51) Int. Cl. H04M 1/04; A45C 11/00; A45C 13/00; A45C 13/10; A45C 1/06; A45F 5/00; H04B 1/3888; H04M 1/02

(52) U.S. Cl. CPC H04M 1/04; A45C 11/00; A45C 13/001; A45C 13/002; A45C 13/1069; A45C 2011/003; A45F 5/00; H04B 1/3888; H04M 1/0283; A45C 2011/002; A45C 1/06

(57) ABSTRACT

A case for a cell phone or tablet, the case having a shell configured to receive a cell phone or tablet device nested therein, the shell having a front side having a device pocket for receiving an electronic device, a rear side comprising a recess, wherein the recess has edges and has a plurality of ferrous metal pads affixed within the recess, each magnet having a magnet position within the recess, a removable plate configured to fit within the recess and having a front and back, comprising, a plurality of magnets affixed on the front of the plate in positions corresponding with the magnet positions, and an accessory affixed to the rear of the plate. The recess may also have a catch at an edge of the recess, and wherein the plate further comprises a protrusion at a side configured to be retained within the catch.

### CROSS-REFERENCE TO RELATED APPLICATION(S)

The present application claims priority to U.S. Provisional Patent Application No. 62/378,649 filed on 23 Aug. 2016, entitled “Cell Phone Case with Reconfigurable Plates” the entire disclosure of which is incorporated by reference herein.

### BACKGROUND OF THE INVENTION

### 1. Field of Invention

This invention relates to mobile device cases; and more particularly, to a case for a cell phone or tablet which is configured with removable plates for utility and aesthetic purposes.

### 2. Description of Related Art

The mobile phone is not just a vessel to make and receive phone calls or emails, but is becoming more and more a staple accessory of the general population. And like other accessories, such as jewelry or purses, there is a desire to match the accessory to the daily activities or current attire. The mobile phone color and design is fixed, and so is the typical casing structure, but a removable plate “shield” can be swapped in and out as easily as changing which watch is worn that day.

The cell phone case protects the phone from impact or dirt, and clings to the cell phone, while permitting normal usage of the phone. There are a myriad of cell phone and tablet cases available on the market, some of which may have attachments built into the rear of the case, such as a belt clip or wallet. With such a crowded art, there remain limited options which promote simple and efficient reconfiguration of the device case. Moreover, there is a need for a case that is readily capable of attaching to other objects in novel ways, without losing convenience or functionality.

For example, a user may want to put his phone in his pocket, without protrusions that catch on the garment pocket. Then, the user needs to view the phone in the car while driving for directions, so the phone must be mounted on the dash. Further, the phone must be clipped on the user's belt after leaving the car, since he is working on a construction site and needs to access the phone while keeping it safe.

Based on the foregoing, there is a need in the art for an adaptable cell phone case that permits connection of the cell phone to different attachments.

### SUMMARY OF THE INVENTION

Briefly summarized, the present invention disclosed a casing structure “shell” for a mobile phone that has a nearly full-length pocket on the back where a removable plate “shield” discreetly resides. This allows for instant customization of the casing structure and mobile phone.

A case for a cell phone or tablet, the case having a shell configured to receive a cell phone or tablet device nested therein, the shell having a front side having a device pocket for receiving an electronic device, a rear side comprising a recess, wherein the recess has edges and has a plurality of metal plates, each metal plate having a metal plate position within the recess, a removable plate configured to fit within the recess and having a front and back, comprising, a plurality of ferrous inserts, serving as magnets, affixed on the front of the plate in positions corresponding with respective metal plate positions, and an accessory affixed to the rear of the plate. The recess may also have a catch at an edge of the recess, and wherein the plate further comprises a protrusion at a side configured to be retained within the catch.

The protrusion may be adapted to pivot within the catch to enable the plate to swing towards and away from the shell. The catch is positioned at the top of the recess, and the magnets are positioned at the bottom of the recess. Further, the accessory is selected from the group consisting of a wallet, a belt clip, a clip, a car vent mount, a suction mount, a CD player mount, a fitness armband, a tilt stand, a portfolio, a molecular-bonding rubber plate to adhere to smooth surfaces such as that used in a GOAT case, a mobile battery, additional memory for use by the device, a SIM card holder, a handlebar mount, a tripod, a popup holder, a device stand, a bottle opener, a finger ring holder, and a utility knife or business card holder.

In some embodiments, the magnets are located so as to be disposed away from areas of a mobile phone or tablet proximate compass functionality in order to prevent interference therewith.

In an embodiment, the plate is adapted to create a flush fit with the back of the shell when positioned within the recess. The edges are stepped and the sides of the plate are stepped to lie along the edges of the recess. In another embodiment, the removable plate is configured to fit within the recess via a friction fitment therebetween.

In other embodiments, the plates and magnets are interchanged as between the plate and case. For example, the magnets may be found on the case and the metal pad(s) for attachment to the magnet may be found on the plate and vice versa.

A method of using a case for an electronic device is disclosed and has the steps of positioning a case having a phone pocket on a front side and a recess on a back side over the back of a mobile device, such that the device fits within, and is retained by, the phone pocket of the case, inserting a plate having a front and back into the recess, first into a catch at the top of the recess to create a latching hold, wherein the plate has an accessory mounted on the back thereof and having one or more magnets on the front, pivoting the plate downwardly towards the case to fit within the recess, retaining the lower portion of the plate magnetically within the recess by the metal plates within the recess, engaging with the magnets on the plate, retaining the upper portion of the plate within the recess by the latching hold, and the user using the accessory to retain the smartphone in a viewing position, on a belt or other garment portion, or otherwise.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 shows a rear elevation of the cell phone case, the rear side having a recessed volume configured to receive a plate, in one embodiment of the present invention.

FIG. 2 shows a side elevation of the cell phone case across Section A-A of FIG. 1, in an embodiment of the present invention.

FIG. 3 a front elevation view of a cell phone case a configured to receive a cell phone device nested therein, in an embodiment of the present invention.

FIG. 4 shows a front elevation view of the removable plate, showing the side that interfaces with the case, in an embodiment of the present invention.

FIG. 5 shows a rear elevation view of the plate with an attachment, according to an embodiment of the present invention.

FIG. 6 shows a side elevation view of the plate, according to an embodiment of the present invention.

### DETAILED DESCRIPTION OF PREFERRED EMBODIMENTS

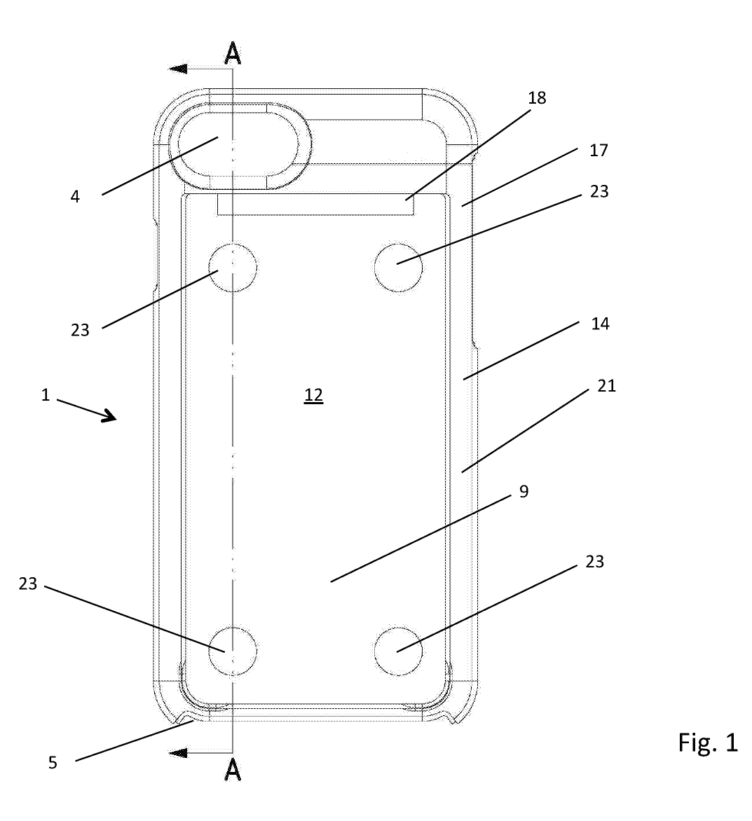

Preferred embodiments of the present invention and their advantages may be understood by referring to FIGS. 1-6, wherein like reference numerals refer to like elements.

This invention relates to a casing structure for a mobile phone with an additional rapid personalization function achieved through the interchangeable back plates.

A casing structure for a mobile phone with removable/replaceable back plates having attachments is disclosed. The casing structure includes a shell that accepts the phone. The main shell has slots allowing all mobile phone functionality, including charging, camera and audio use. The main shell also has raised regions along the side to accommodate buttons on the phone. The back side of the main shell also has a pocket to accept the back plates. The back plates are designed to almost exactly fit into the main shell pocket. The back plates are removable and replaceable and are created to remain in the main shell pocket during normal phone usage, until removed by patron.

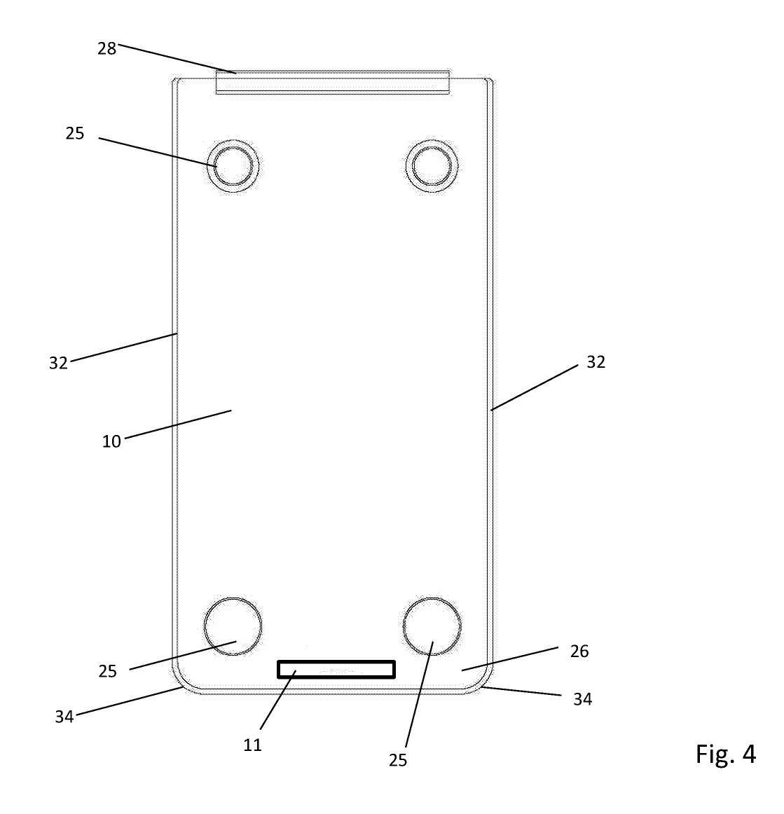

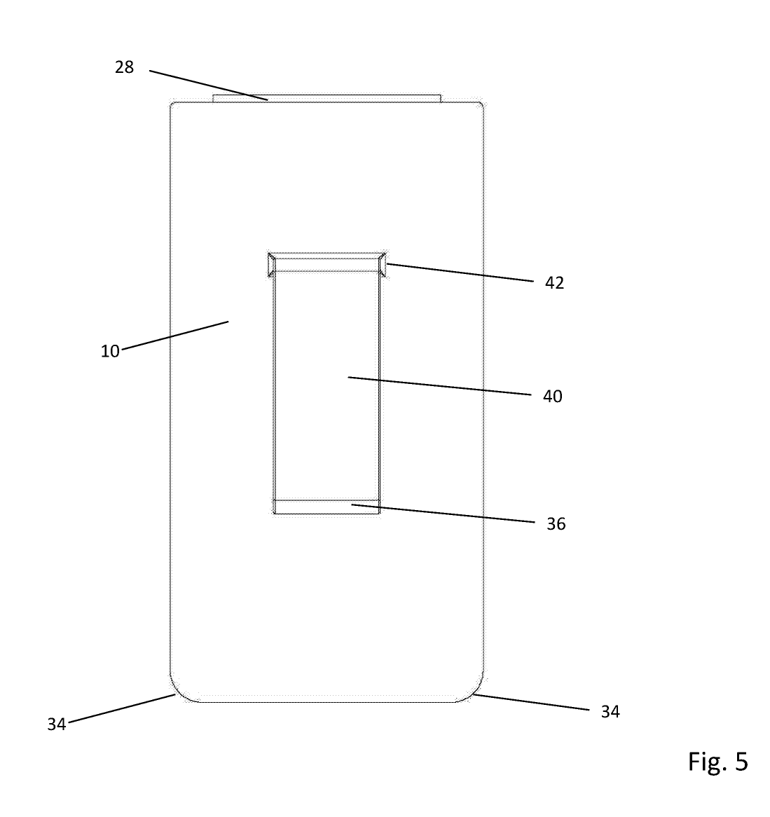

FIGS. 1-3 show views of shell 1 which may serve as a mobile device case (protective case, etc.). Shell 1 shall also be referred to herein as shell/case 1. FIG. 4 illustrates adaptable plate 10 which engages shell 1. FIG. 1 shows a rear elevation view of the shell 1, with the outward-facing side 21 of base 15 (outward-facing when the case is mounted on the phone) having recess 9 for receiving adaptable plate 10 (shown in FIG. 5). Recess 9 is generally a flat inset into the outward-facing side of the case, recessed by an amount similar to the thickness of plate 10 which is adapted to receive recesses in the case within which to allow magnets (from plate 10) to fit, creating a shear contact point between the magnets of the plate and shell/case itself.

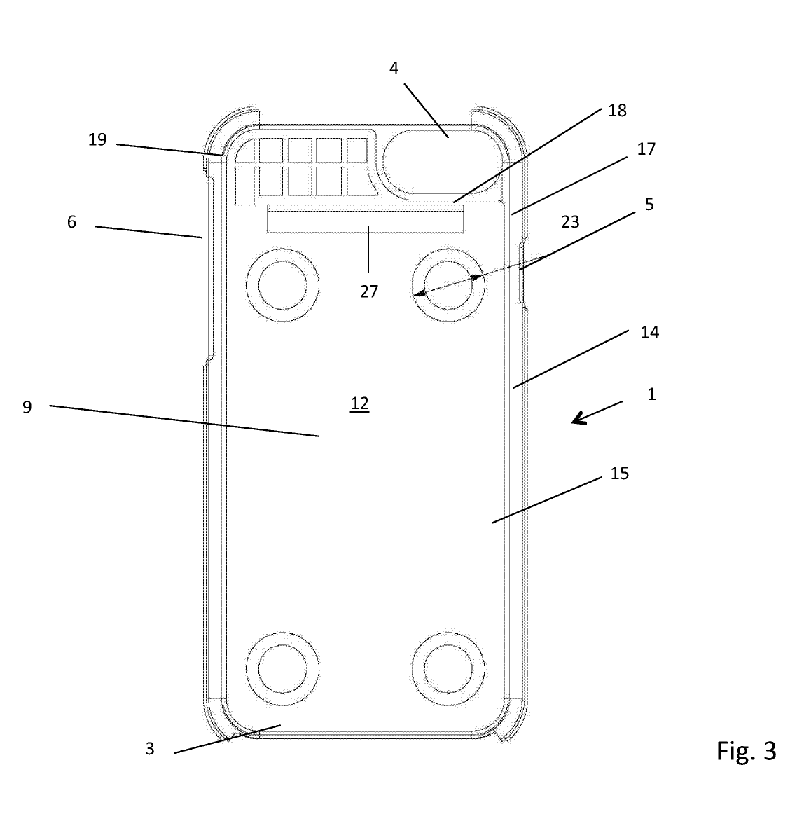

As shown in FIG. 4, plate 10 has corresponding magnets 25 for engaging the metal indentations/pads 23 shown in FIG. 1. In one embodiment, as shown in FIG. 1, metal plates 23 are four in number and they are spaced apart across recess 9. In some embodiments, magnets referenced herein are formed from a rare earth magnet such as a neodymium magnet and ideally a compound of neodymium with a transition metal. In some embodiments, magnets 25 (as show in FIG. 1) are located so as to be disposed away from areas of a mobile phone or tablet proximate compass functionality in order to prevent interference therewith. For instance, for a phone having a compass near the top portion of a mobile phone, magnets on the plate may be located for placement on the case away from the compass functionality of the phone (e.g., near the bottom of the shell). In one embodiment, with reference to FIGS. 1 and 3, the top of recess 9 comprises an indent (or overhang) 18 in the recess 9 edge. In another embodiment, strip magnet 11 is provided along the bottom of plate 10 for engaging shell/case 1. In some embodiments, protrusion 28 may be more pronounced so as to a form an extended lip. In other embodiments, protrusion 28 may be substituted with a latch as further explained herein.

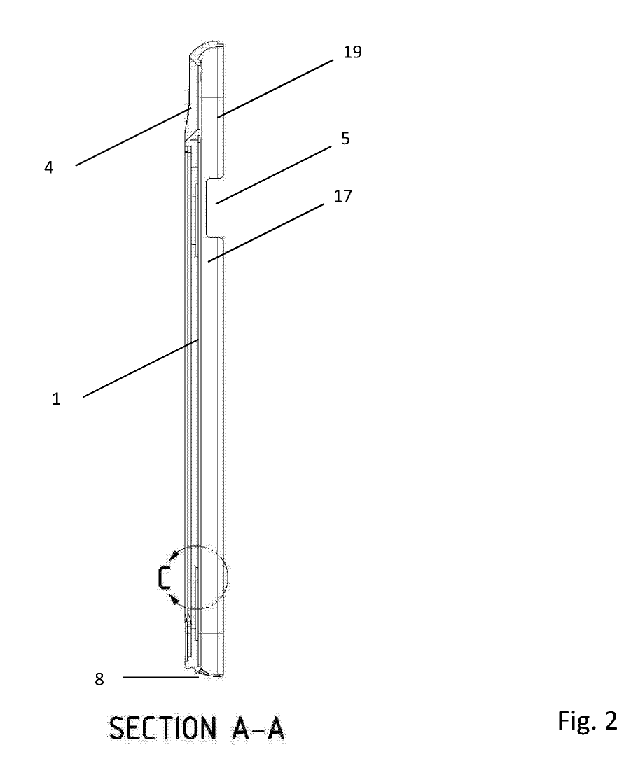

FIG. 3 shows the front view of the shell 1 forming pocket 12 as defined by recess 9, in base 15, that coincides with the back of a mobile device (not shown), and generally perpendicularly-rising edges 17, adapted to extend above and retain a mobile phone (not shown) or a tablet (not shown) that is inserted into pocket 12, thereby serving as a mobile phone pocket or tablet pocket, respectively, as the case may be. Shell 1 may be formed by a process of injection molding from a polycarbonate exterior over-molded with thermoplastic elastic (TPE) or thermoplastic polyurethane (TPU). In one embodiment, pocket 12 has a step therein, along the edges. so as to define a storage area therein. Edges 17 may be curved to adapt to hold the edges of a mobile phone (not shown) or other electronic device. In yet another embodiment, edges 17 have an interior-facing ledge 19 to retain a mobile device within shell 1, such that the ledge-rimmed opening of pocket 12 is slightly smaller than the mobile device, and when the device is inserted it is retained by the ledge 19. In addition, each mobile device has a number of peripheral or accessory attachments or features that require access to the exterior of a case. Therefore, according to each mobile phone design, there are a plurality of shell cutouts e.g., 5, 6, 8 and protrusions to allow for mobile phone form and functionality, including a camera lens cutout 4, a power port 3 (such as micro-USB or Apple adapter), power button access 5, volume access 6, and a headphone jack 8 (as shown in FIG. 2). Shell cutouts and protrusions may differ for different mobile phone makes and models. In one embodiment, catch 27 comprises a cutout in base 15 to receive protrusion 28 in adaptable plate 10.

Shown in FIGS. 4-6, an adaptable plate 10 may be removed and replaced from recess 9 in plate 10. When mounted within the recess 9, plate 10 is flush with the outside edges 19 of the recess 9 of FIG. 3. Plate 10 has corresponding magnets for engaging with the metal pads 23 within recess 9, to removably connect with the rear of the shell 1. In some embodiments, plate 10 may be formed from polycarbonate.

In some embodiments, plate 10 has protrusion 28 (shown in FIG. 4) at its upper edge 25 for engaging catch 27 (of FIG. 3) In these embodiments, the protrusion 28 is slightly thinner than the catch 27, and fits within it to create a mechanical latch (alternatively known as the “top” latch), and plate 10 pivots around the latch as it is magnetically connected to recess 9 and released therefrom. With reference back to FIG. 4, lower edge 26 of plate 10 has one or more magnets 25 for engaging with the metal plates 23 of recess 9. In one embodiment, plate 10 has an elongated magnet 11 set within the material of the plate, instead of magnets 25 along lower edge 26 shown in FIG. 4, to interact with and be retained by the a corresponding metal plate within the recess 9. In this embodiment, protrusion 28 of plate 10 is retained within catch 27 (of FIG. 1), and the lower edge 26 is retained in place by magnet 11, either solely or in combination with magnets 25 located at the lower edge of plate 10. In one embodiment, plate 10 has a stepped edge 32 for ease of placement within and removal from recess 9 (shown in FIG. 1). Further, several or all corners of the plate 10 may be rounded, rather than having sharp edges, for safety considerations.

In other embodiments, plate 10 can be attached to the recess 9 via a friction fitment, or with snapping features. Alternatively, plate 10 can be attached to recess 9 via one or more magnets. In an embodiment, one side of the plate 10 is latched with the recess 9, and the other side has a magnetic attachment to the recess 9. Other attachment means known to those having skill in the art can be similarly implemented. There may also be a cut-out finger catch at the lower end 26 of the plate 10 to permit a nail to be inserted underneath and to pull the plate 10 up and break the magnetic retention. Alternatively, the crack between the mounted plate 10 and the recess edge is wide enough for a fingernail to be inserted.

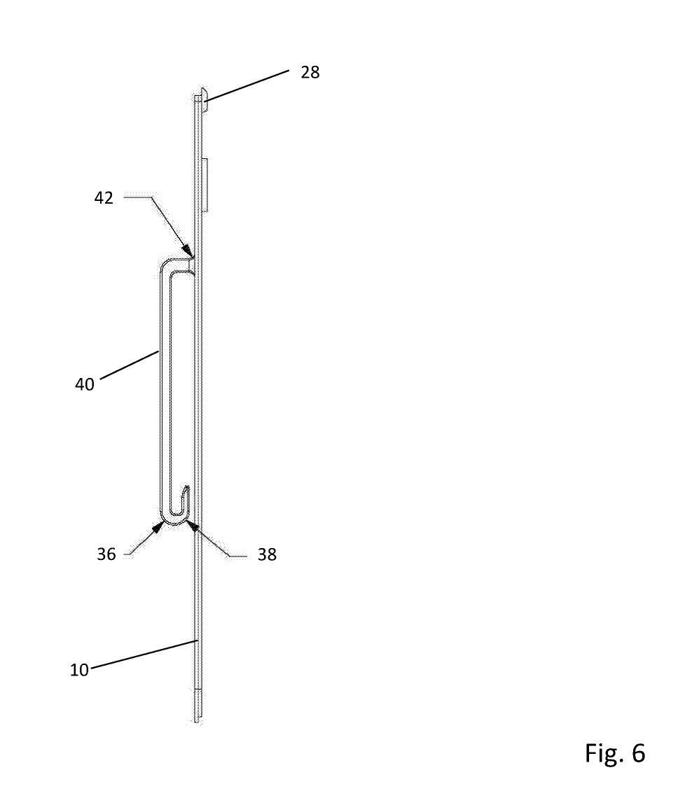

With reference to FIGS. 5 and 6, plate 10 has an attachment or accessory attached thereto and/or protruding therefrom. In one embodiment, the attachment is clip 40 (e.g., belt clip), having an inwardly-rounded lower section 36 to prevent snagging, and lower hook 38. Clip 40 is resilient and moves away from plate 10 when pressure is applied, to permit a belt to slip between clip 40 and plate 10, before resiliently returning to a rest position. The top of clip 40 juts out of plate 10 with reinforced section 42. Clip 40 flexes according to the material from which it is made, or may have a spring-loaded pivot to keep pressure of the end of the clip against the back of the plate 10. Without limitation, the attachment may also comprise a wallet, clip, car vent mount, suction mount, CD player mount, fitness armband, tilt stand, portfolio, molecular-bonding rubber plates to adhere to smooth surfaces such as that used in a GOAT case, mobile battery, additional memory, SIM card holder, bicycle handlebar mount, tripod, popup holder or stand, bottle opener, finger ring holder, utility knife or business card holder, or other garment or similar object and other needed attachments known in the art. Each of the attachments is removably connected to the plate as described above, and the plate, in turn, is removably connected to the case.

In some embodiments, removable plate 10 can depict a sports team or other aesthetic design. In some embodiments, the team sticker or team logo may be sublimated or printed to plate 10. In other embodiments, the removable plate 10 may incorporate lights, such as LED lights, or other features. In yet other embodiments, removable plate 10 can simply be removed to expose the inner recess 9 of the case for attaching with one or more mounting accessories, such as a car mount for securing the case and device therein to a vehicle dash panel, or a stand for fixing a hands-free placement of the device, for example next to a bed where a video can be viewed hands-free.

The case may be used by a user positioning the case over the back of a mobile device, such as a smartphone, and wherein the device fits within a phone pocket of the case and is retained by ledges extending from the edges of the pocket. Once the case is secured on the phone, plate 10 having an accessory mounted thereon is inserted into the recess 9, first into catch 127 at the top of recess 9 to create a latching hold. Plate 10 is pivoted downwardly towards the case to fit within the recess, whereby a magnetic retention is engaged between the lower edge 26 of plate 10 and the lower portion of recess 9, with the upper edge of the plate being retained within the upper portion of recess 9. An accessory is used by the user to retain the smartphone in a viewing position, on a belt or other garment portion, or otherwise.

The invention has been described herein using specific embodiments for the purposes of illustration only. It will be readily apparent to one of ordinary skill in the art, however, that the principles of the invention can be embodied in other ways. As noted, in some embodiments, the plates and magnets are interchanged as between the plate and case. For example, the magnets may be found on the case and the metal pad(s) for attachment to the magnet may be found on the plate and vice versa.

Therefore, the invention should not be regarded as being limited in scope to the specific embodiments disclosed herein, but instead as being fully commensurate in scope with the following claims.

1. A case for a cell phone or tablet, the case comprising:
a removable plate;
a shell configured to receive a cell phone or tablet device nested therein, the shell having a front side having a device pocket for receiving an electronic device, and a rear side having a recess with a plurality of means for magnetically engaging the removable plate, affixed thereto, the shell further having a catch at an edge of the recess;
the removable plate configured to fit within the recess and having a front and back, including a plurality of means affixed on the front of the plate in positions for magnetically engaging the plurality of means in the recess for magnetically engaging the removable plate, the removable plate further including a protrusion adapted to secure the removable plate within the recess in connection with engaging and being retained within the catch; and
an accessory affixed to or integrally formed from the rear of the plate.

2. (canceled)

3. (canceled)

4. (canceled)

5. The case of claim 1, wherein the catch is positioned at the top of the recess, and the means for magnetically engaging the removable plate comprises a plurality of magnets which are positioned for engagement at the bottom of the recess.

6. The case of claim 1, wherein the accessory is selected from the group consisting of a wallet, a clip, a car vent mount, a suction mount, a CD player mount, a fitness armband, a tilt stand, a portfolio, a molecular-bonding rubber plate to adhere to smooth surfaces such as that used in a GOAT case, a mobile battery, additional memory for use by the device, a SIM card holder, a handlebar mount, a tripod, a popup holder, a device stand, a bottle opener, a finger ring holder, a utility knife, a business card holder and a combination thereof.

7. The case of claim 1 wherein the plate is adapted to create a flush fit with the back of the shell when positioned within the recess.

8. The case of claim 1 wherein the edges are stepped, and the sides of the plate are stepped correspondingly to lie along the edges of the recess.

9. The case of claim 1, wherein the removable plate is configured to fit within the recess via a friction fitment therebetween.

10. The case of claim 1 wherein the shell is formed from a polycarbonate exterior over-molded with thermoplastic elastic.

11. The case of claim 1 wherein the removable plate is formed from a polycarbonate material.

12. A removable plate, having a front and a back, configured to fit within a recess of a mobile device shell, the plate including:
means affixed to the front of the plate for magnetically engaging positions on the mobile device shell;
a protrusion adapted to secure the removable plate within the recess in connection with engaging and being retained within a catch on the edge of the mobile device shell; and
an accessory affixed to or integrally formed from the rear of the plate.

13. A removable plate as recited in claim 12 wherein the means affixed to the front of the plate is a rare earth magnet.

14. A removable plate as recited in claim 12 wherein the means affixed to the front of the plate is a neodymium magnet.

15. A removable plate as recited in claim 12 wherein the means affixed to the front of the plate is a magnet formed from a compound of neodymium with a transition metal.

16. A removable plate as recited in claim 12 where the removable plate is formed from a polycarbonate material.

17. A removable plate as recited in claim 12 wherein the means affixed to the front of the plate is metal plate for engaging a magnet.

18. (canceled)

19. (canceled)
